(19) United States
(12) Patent Application Publication
(10) Pub. No.: US 2013/0250975 A1
(43) Pub. Date: Sep. 26, 2013

(54) METHOD AND DEVICE FOR PACKETIZING A VIDEO STREAM

(71) Applicants: Sang Woo Ahn, Daejeon-si (KR); Yong Ju Cho, Seoul (KR)

(72) Inventors: Sang Woo Ahn, Daejeon-si (KR); Yong Ju Cho, Seoul (KR)

(21) Appl. No.: 13/990,903

(22) PCT Filed: Jan. 24, 2011
(86) PCT No.: PCT/KR2011/000466

§ 371 Date: May 31, 2013

(30) Foreign Application Priority Data
Dec. 6, 2010 (KR) 10-2010-0123847

(51) Int. Cl. H04L 29/06

(52) U.S. Cl. CPC H04L 69/04
USPC 370/474

(57) ABSTRACT

A digital broadcasting system provides a method and device for packetizing a video stream. The packetizing device includes: a video frame check block for classifying an encoded video stream according to the frame type; a header setting block for setting a packet header for each of the classified frames; and a packetizing block for packetizing a video frame on the basis of the set packet header. The frame type may be one of an intra-coded (I) frame, a predicted (P) frame, and a bi-predictive (B) frame. Since a digital broadcasting stream is efficiently packetized, overhead due to a typical synchronization packet may be reduced, and accordingly, bandwidth may be efficiently used.

### TECHNICAL FIELD

The present invention relates to digital broadcasting, and more particularly, to a method and apparatus for effective packetization supporting random access of a digital broadcasting stream.

### BACKGROUND ART

In recent years, digital broadcasting techniques including terrestrial, satellite, cable, internet Protocol TV (IPTV), digital multimedia broadcasting (DMB), or the like have continuously been developed. Digital broadcasting systems may use various types of a transport protocol to transmit audio, video, and data streams. For example, a packetized elementary stream (PES) and a transport stream (TS) which are defined in the moving picture experts group (MPEG)-2 standard may be widely used as the transport protocol. In addition, an MPEG-4 sync layer (SL) or a real time protocol (RTP) may be used as the transport protocol for Internet-based transmission, and optionally may be combined organically with the MPEG-2 standard so as to be used for packetizing and transmitting various media.

Meanwhile, there has recently been an explosive increase in the interest on 3 dimensional (3D) images in various fields such as movies, broadcasting, etc. To cope with such a trend, new techniques related to the 3D images are being developed rapidly. The interest on the 3D images is particularly remarkable in the broadcasting field, and it is scheduled to introduce a 3D image technique in all broadcasting fields including satellite, cable, terrestrial, and DMB broadcasting. The 3D image technique can use a packetization technique based on the MPEG-2 standard as a transport protocol, similarly to the digital broadcasting technique. However, the MPEG-2 standard is established for the purpose of a broadcasting environment, and aims at reliability rather than efficiency. Therefore, this standard has a limitation in case of transmitting various media. In particular, the MPEG-2 standard is limitedly applied to 3D broadcasting that requires a large volume of data transmission or an ultra high definition TV (UHDTV) technique which has recently drawn attention. As a result, there is an active attempt to introduce a new transport protocol called MPEG media transport (MMT) in replacement of the conventional transport protocol.

Accordingly, there is a need for a method and apparatus for effectively packetizing a digital broadcasting stream.

### SUMMARY OF INVENTION

### Technical Problem

The present invention provides a method and apparatus for packetizing a video stream.

### Technical Solution

In an aspect, an apparatus for packetizing a video stream is provided. The apparatus include a video frame check block for classifying an encoded video stream according to a frame type, a header configuration block for configuring a packet header including a field indicating the frame type for each of the classified video streams, and a packetization block for packetizing the video frame based on the configured packet header.

The frame type may be any one of an intra-coded (I) frame, a predicted (P) frame, and a bi-predictive (B) frame.

The packet header may include a field indicating whether random access is possible.

The packet header may include a field indicating whether the packet header is shared with a specific frame. If a value of the field indicating whether the packet header is shared is 1, the packet header may further include a field indicating a frame number of the specific frame. If a value of the field indicating whether the packet header is shared is 1, the specific frame may be a frame corresponding to a left image of a 3 dimensional (3D) image.

The packet header may include a field indicating a decoding time or an output time.

The apparatus may further include a transmission multiplexing block for performing transmission multiplexing on the packetized video frame and for transmitting the frame to a receiver.

In another aspect, a method of packetizing a video stream in a digital broadcasting system is provided. The method include classifying an encoded video stream according to a frame type, configuring a packet header including a field indicating the frame type for each of the classified video streams, and packetizing the video frame based on the configured packet header.

The frame type may be any one of an intra-coded (I) frame, a predicted (P) frame, and a bi-predictive (B) frame.

The packet header may include a field indicating whether random access is possible.

The packet header may include a field indicating whether the packet header is shared with a specific frame. If a value of the field indicating whether the packet header is shared is 1, the packet header may further include a field indicating a frame number of the specific frame. If a value of the field indicating whether the packet header is shared is 1, the specific frame may be a frame corresponding to a left image of a 3 dimensional (3D) image.

The packet header may include a field indicating a decoding time or an output time.

The method may further include performing transmission multiplexing on the packetized video frame and transmitting the frame to a receiver.

### Advantageous Effects

Overhead caused by the conventional synchronization packetization can be decreased by effectively packetizing a digital broadcasting stream, thereby capable of effectively using a bandwidth.

### DESCRIPTION OF DRAWINGS

FIG. 1 is a block diagram showing a packetization process in a typical transport protocol.

FIG. 2 shows a typical packetization process of a video or audio stream in digital broadcasting.

FIG. 3 is a block diagram showing an example of an apparatus for packetizing a video stream according to the proposed invention.

FIGS. 4 and 5 shows an example of packetization according to the proposed packetization method.

FIG. 6 is a flowchart showing an embodiment of a method of packetizing a video stream according to the proposed invention.

### MODE FOR INVENTION

Hereinafter, some embodiments of the present invention are described in detail with reference to the accompanying drawings in order for those skilled in the art to be able to readily implement the invention. However, the present invention may be modified in various different ways and are not limited to the following embodiments. In order to clarify a description of the present invention, parts not related to the description are omitted, and the same reference numbers are used throughout the drawings to refer to the same or like parts. Further, a description of parts which can be easily understood by those skilled in the art is omitted.

When it is said that any part “includes (or comprises)” any constituent element, it means that the corresponding part may further include other constituent elements unless otherwise described without excluding other constituent elements.

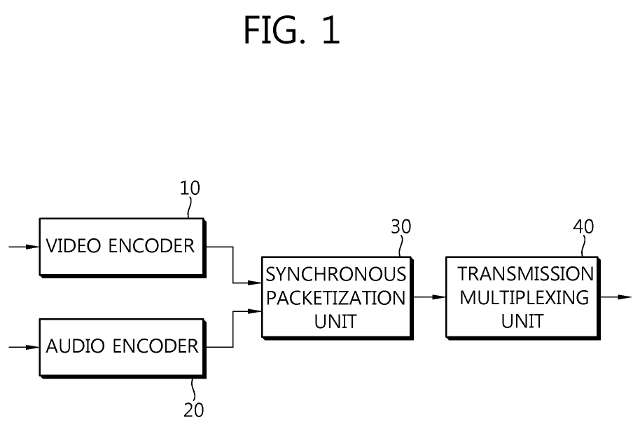

FIG. 1 is a block diagram showing a packetization process in a typical transport protocol.

Referring to FIG. 1, a video encoder 10 encodes an input video signal to generate a video stream, and an audio encoder 20 encodes an input audio signal to generate an audio stream. A synchronous packetization unit 30 performs synchronous packetization on the video stream and the audio stream. The synchronous packetization process is performed to support synchronization by inserting timing information to the video stream and the audio stream. A transmission multiplexing unit 40 performs transmission multiplexing on the synchronously packetized packet and then transmits the packet.

The MPEG-2 standard can use a packetized elementary stream (PES) in the synchronous packetization process. The PES packet can be used to synchronize the video stream and the audio stream. In addition, a transport stream (TS) packet can be used in the transmission multiplexing process. By using the TS stream, synchronization between a server and a mobile station can be supported, and transmission multiplexing can be performed. Meanwhile, the PES packet is not packetized differently for each video frame (i.e., an intra-coded (I) frame, a predicted (P) frame, and a bi-predictive (B) frame) but is collectively packetized in the same manner, which may result in occurrence of overhead.

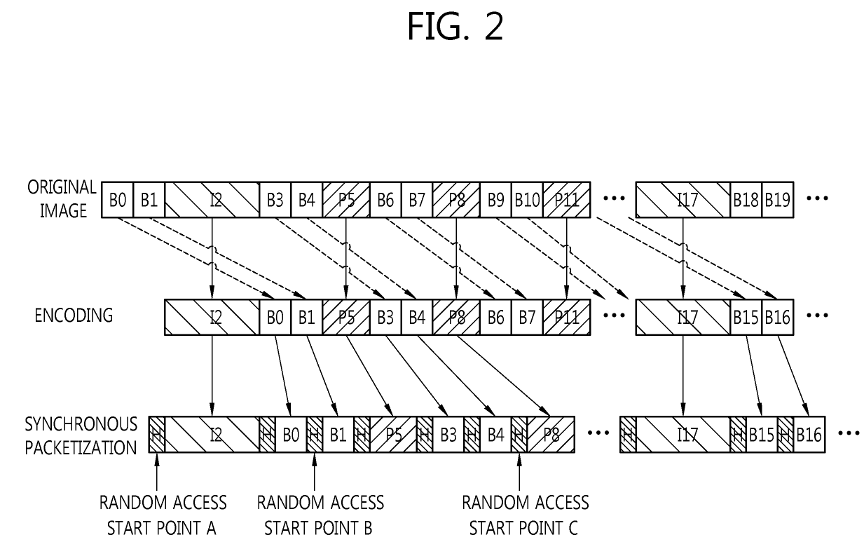

FIG. 2 shows a typical packetization process of a video or audio stream in digital broadcasting.

When an original image is encoded, encoding is performed to respective frames in a cross manner. This is because the original image includes an I frame, a P frame, and a B frame. The I frame is a frame fully containing information of the frame, and has the best image quality but requires great capacity to that extent. The P frame is a unidirectional predicted frame, and includes information on what is different from a previous frame. The P frame has smaller capacity than the I frame, but has image quality which decreases in proportion thereto. The B frame is a bi-directional prediction frame, and includes information on what is different from both a previous and a next frame. The B frame has smaller capacity than the P frame, but image quality decreases to that extent. Since the P frame and the B frame use at least one of the previous frame and the next frame, encoding shall be performed in the order of the I frame, the P frame, and the B frame.

Referring to FIG. 2, frames B0, B1, I2, B3, B4, P5, B6, and so on of the original image are crossed in an encoding process and thus are encoded in the order of I2, B0, B1, P5, B3, B4, P8, B6, and so on. Accordingly, a receiver can decode the frames I2 and P5 necessary for decoding of the frames B3 and B4 before decoding the frames B3 and B4. The encoded I, P, and B frames are sequentially subjected to synchronous packetization with respect to an essential stream (ES) included therein. In this case, a PES packet conforming to the MPEG-2 standard may be used. After performing synchronous packetization, a stream transmitted through the transmission packetization is restored to the original image in the receiver.

Meanwhile, the receiver does not always start to access to a first position of the stream. The receiver may start to access to any position of the stream by performing an operation of changing a channel. That is, the receiver may start to access to any frame among the I, P, and B frames in the stream. In this case, if the access starts from the I frame, for example, a random access start point A, then all frames can be restored without any problem. However, if the access starts from the B frame or the P frame, for example, a random access start point B or a random access start point C, then the frame is meaningless data until the next I frame is received. That is, all pieces of data received prior to the I frame are treated as unusable data in the receiver, and thus a packet header H generated in the synchronous packetization process generates waste of a bandwidth.

An effective packetization method and apparatus for supporting random access of a video stream will be described hereinafter.

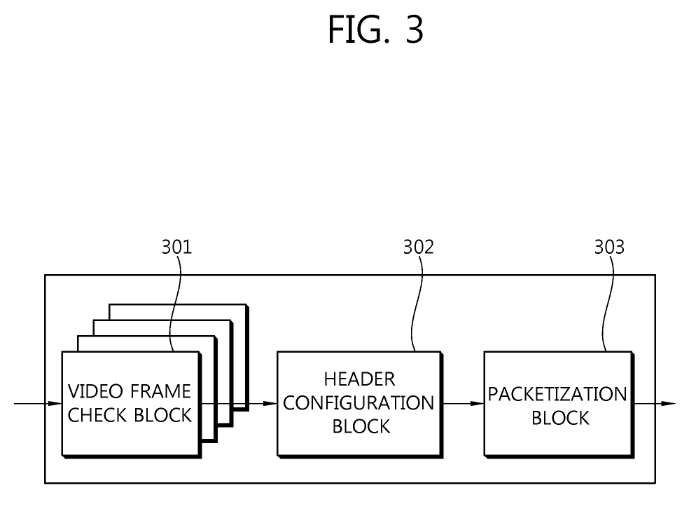

FIG. 3 is a block diagram showing an example of an apparatus for packetizing a video stream according to the proposed invention.

The packetization apparatus of FIG. 3 includes a video frame check block 301, a header configuration block 302, and a packetization block 303. The video frame check block 301 classifies an encoded video stream for each frame. This is to configure the most effective header for each frame according to a frame type. The header configuration block 302 configures a packet header for each frame according to the classified video stream. The header configuration block 302 supports synchronization by setting time information. This may be identical to PTS and DTS setting of the MPEG-2 standard and CTS and DTS setting of the MPEG-4 standard. The packetization block 303 packetizes the video frame on the basis of the configured packet header.

Table 1 shows an example of a packet header configured by the header configuration block 302 of FIG. 3.

TABLE 1

| Field | Number of bits |
|---|---|
| Start_indicator | 16 |
| Packet_length | 16 |
| Payload_stream_type | 8 |
| Packet_dependency | 1 |
| If(Packet_depencency == ‘0’) { | |
| Random_access_indicator | 1 |
| Payload_frame_type | 3 |
| Frame_sequence_number | 8 |
| reserved | 3 |
| If(Payload_frame_type == ‘001’) { | |
| Last_frame_sequence_number | 8 |
| Decoding_time_stamp | 33 |
| reserved | 3 |
| Presentation_time_stamp | 33 |
| reserved | 3 |
| } | |
| } else { | |
| Dependent_frame_sequence_number | |
| } | |
| For(i=0;i<N;i++) { | |
| Packet_data_byte | 8 |
| } | |

Each field has the following meaning.
Start_indicator: It indicates a start point of the packet. The Start_indicator field may have a length of 16 bits and may have a value of 0x1047.
Packet_length: It indicates a length from a Payload_stream_type field to a Packet_data_byte field to be described below. The Packet_length field may have a length of 16 bits.
Payload_stream_type: It indicates a type of payload data. The Payload_stream_type field may have a length of 8 bits. Table 2 shows an example of a mapping relation between a value of the Payload_stream_type field and a payload type.

TABLE 2

| Value | Content |
|---|---|
| 0x01 | Video (ISO/IEC 11172-2 or ISO/IEC 13818-2 or |
| | ISO/IEC 14496-2) |
| 0x02 | Audio (ISO/IEC 11172-3 or ISO/IEC 13818-3 or |
| | ISO/IEC 14496-3) |
| 0x03 | Video (H.264 or ISO/IEC 14496-10) |
| 0x04~0xFF | Reserved |

Packet_dependency: It indicates sharing of a packet header if a payload is different but the packet header is identical. The Packet_dependency field may have a length of one bit. The Packet_dependency field has a value of 0 in general, but has a value of 1 if the packet header is identical, similarly to a left image and a right image of a 3D image.
Random_access_indicator: It indicates whether random access is possible for the video stream. The Random_access_indicator field may have a length of one bit. In case of video, it corresponds to the I frame. If the type of payload data is advance video coding (AVC), it corresponds to an IDR frame.
Payload_frame_type: It indicates a type of payload data including a frame type (e.g., I, P, and B frames) or decoding information. The Payload_frame_type field may have a length of 3 bits. In the AVC, the decoding information is the same as initialization information such as a sequence parameter set (SPS) or a picture parameter set (PPS). Table 3 shows an example of a mapping relation between a value of the Payload_frame_type field and the frame type.

TABLE 3

| Value | Content |
|---|---|
| ‘000’ | Reserved |
| ‘001’ | I frame (or IDR frame) |
| ‘010’ | P frame |
| ‘011’ | B frame |
| ‘100’ | Decoding Information |
| ‘101’~‘111’ | Reserved |

Frame_sequence_number: It indicates a frame number in the video stream.

The Frame_sequence_number field may have a length of 8 bits, and has a value in the range of 0 to 254 for operation of a modulo counter. The frame number is set to 0x00 in cthe I frame, and may increase by 0x01 until the next I frame appears. However, it may set to 0xFF in case of the decoding information other than the I, P, and B frames.
Last_frame_sequence_number: If case of the I frame, it indicates a frame number immediately before the next I frame appears. The Last_frame_sequence_number field has a length of 8 bits. According to the Last_frame_sequence_number field, the number of P or B frames between I frames can be known, and a receiving end can compensate and calculate a time value of the P and B frames.

Decoding_time_stamp: It indicates a decoding time of a frame included in a payload. The Decoding_time_stamp field may have a length of 33 bits.
Presentation_time_stamp: It indicates an output time of the frame included in the payload. The Presentation_time_stamp field may have a length of 33 bits.
Dependent_frame_sequence_number: If the Packet_dependency field has a value of 1, it indicates a frame number that shares a header value.
Packet_data_byte: It is a field for carrying and sending actual data. The Packet_data_byte field may have a length of 8 bits.

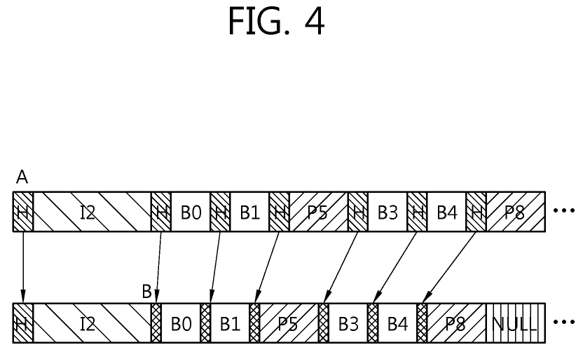

FIG. 4 shows an example of packetization according to the proposed packetization method. Referring to FIG. 4, a packet header of an I frame does not have a significant change in a bandwidth, but a size of a bandwidth used by a packet header of a P or B frame decreases according to the proposed method. Therefore, the bandwidth is saved by an amount corresponding to NULL.

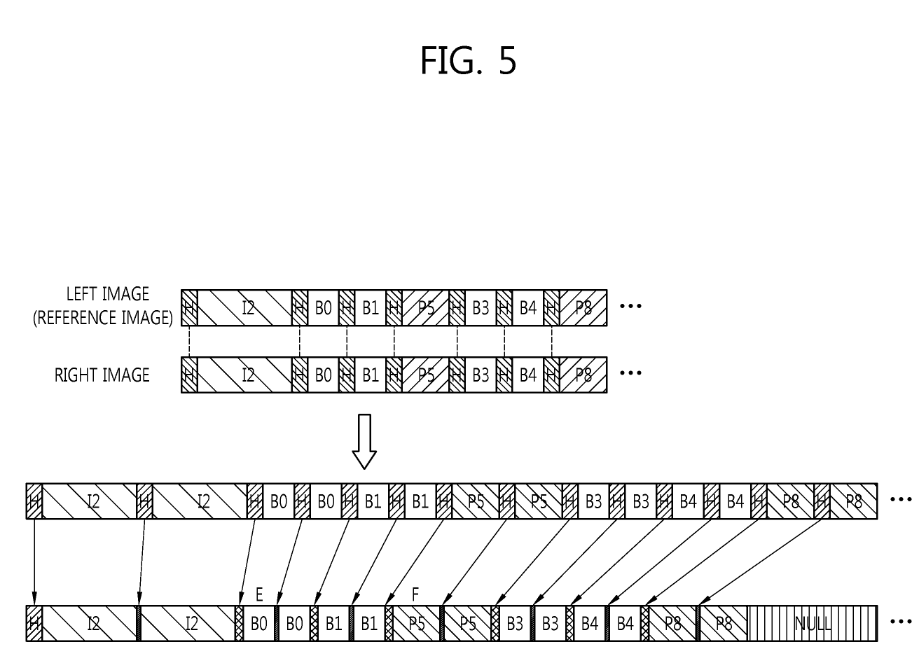

FIG. 5 shows another example of packetization according to the proposed packetization method. The example of FIG. 5 shows a case in which the proposed packetization method is applied to a 3D image including a left image and a right image. In general, the left image and the right image are synchronized for each frame, and the synchronized left and right images have the same packet header when they are subjected to the conventional synchronization packetization process. Therefore, overhead of the packet header becomes greater than that of a single image. When the proposed packetization method is applied to the left image and the right image, a different packet header is generated for each frame and thus a bandwidth occupied by a packet header of a P or B frame may decrease. In addition, since the packet header of the left image is identical to the packet header of the right image, a bandwidth occupied by the packet header of the right image may further decrease.

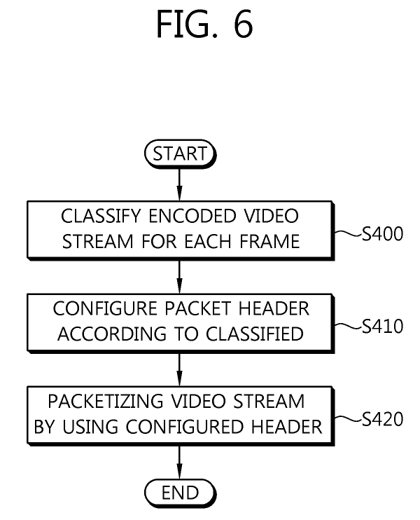

FIG. 6 is a flowchart showing an embodiment of a method of packetizing a video stream according to the proposed invention. In step S400, a packetization apparatus classifies an encoded video stream for each frame. In step S410, the packetization apparatus configures a packet header for each frame according to the classified video stream. In step S420, the packetization apparatus packetizes the video frame on the basis of the configured packet header.

The present invention can be implemented using hardware, software, or a combination of them. In the hardware implementations, the present invention can be implemented using an Application Specific Integrated Circuit (ASIC), a Digital Signal Processor (DSP), a Programmable Logic Device (PLD), a Field Programmable Gate Array (FPGA), a processor, a controller, a microprocessor, other electronic unit, or a combination of them, which is designed to perform the above-described functions. In the software implementations, the present invention can be implemented using a module performing the above functions. The software can be stored in a memory unit and executed by a processor. The memory unit or the processor can use various means which are well known to those skilled in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the spirit and scope of the appended claims.

1. An apparatus for packetizing a video stream, the apparatus comprising:
a video frame check block for classifying an encoded video stream according to a frame type;
a header configuration block for configuring a packet header including a field indicating the frame type for each of the classified video streams; and
a packetization block for packetizing the video frame based on the configured packet header.

2. The apparatus of claim 1, wherein the frame type is any one of an intra-coded (I) frame, a predicted (P) frame, and a bi-predictive (B) frame.

3. The apparatus of claim 1, wherein the packet header includes a field indicating whether random access is possible.

4. The apparatus of claim 1, wherein the packet header includes a field indicating whether the packet header is shared with a specific frame.

5. The apparatus of claim 4, wherein if a value of the field indicating whether the packet header is shared is 1, the packet header further includes a field indicating a frame number of the specific frame.

6. The apparatus of claim 4, wherein if a value of the field indicating whether the packet header is shared is 1, the specific frame is a frame corresponding to a left image of a 3 dimensional (3D) image.

7. The apparatus of claim 1, wherein the packet header includes a field indicating a decoding time or an output time.

8. The apparatus of claim 1, further comprising a transmission multiplexing block for performing transmission multiplexing on the packetized video frame and for transmitting the frame to a receiver.

9. A method of packetizing a video stream in a digital broadcasting system, the method comprising:
classifying an encoded video stream according to a frame type;
configuring a packet header including a field indicating the frame type for each of the classified video streams; and
packetizing the video frame based on the configured packet header.

10. The method of claim of 9, wherein the frame type is any one of an intra-coded (I) frame, a predicted (P) frame, and a bi-predictive (B) frame.

11. The method of claim 9, wherein the packet header includes a field indicating whether random access is possible.

12. The method of claim 9, wherein the packet header includes a field indicating whether the packet header is shared with a specific frame.

13. The method of claim 12, wherein if a value of the field indicating whether the packet header is shared is 1, the packet header further includes a field indicating a frame number of the specific frame.

14. The method of claim 12, wherein if a value of the field indicating whether the packet header is shared is 1, the specific frame is a frame corresponding to a left image of a 3 dimensional (3D) image.

15. The method of claim 9, wherein the packet header includes a field indicating a decoding time or an output time.

16. The method of claim 9, further comprising performing transmission multiplexing on the packetized video frame and transmitting the frame to a receiver.
